(19) United States
(12) Patent Application Publication
(10) Pub. No.: US 2017/0229878 A1
(43) Pub. Date: Aug. 10, 2017

(54) BATTERY MANAGEMENT APPARATUS AND BATTERY MANAGEMENT METHOD

(71) Applicant: Samsung Electronics Co., Ltd., Suwon-si (KR)

(72) Inventors: Myung Hoon KIM, Seoul (KR); Dae Ryong JUNG, Seongnam-si (KR); Duk Jin OH, Seoul (KR); Ju Wan LIM, Suwon-si (KR)

(73) Assignee: Samsung Electronics Co., Ltd., Suwon-si (KR)

(21) Appl. No.: 15/420,833

(22) Filed: Jan. 31, 2017

(30) Foreign Application Priority Data
Feb. 4, 2016 (KR) 10-2016-0014359

(51) Int. Cl. H02J 7/00; H01M 10/42; H01M 10/63; H01M 10/48

(52) U.S. Cl. CPC H02J 7/007; H01M 10/48; H01M 10/425; H01M 10/63; H01M 2010/4271

(57) ABSTRACT

A battery management apparatus including: a state of charge (SOC) estimator configured to estimate an SOC of a battery; and a storage temperature controller configured to control a storage temperature of the battery based on the SOC of the battery.

### CROSS-REFERENCE TO RELATED APPLICATIONS

This application claims the benefit under 35 USC 119(a) of Korean Patent Application No. 10-2016-0014359 filed on Feb. 4, 2016, in the Korean Intellectual Property Office, the entire disclosure of which is incorporated herein by reference for all purposes.

### BACKGROUND

1. Field

The following description relates to a battery management technology, and more particularly, to a battery management apparatus and a battery management method.

2. Description of Related Art

A battery pack including secondary batteries may have a large capacity and high power so as to be used, for example, as a power source in an electric vehicle or a hybrid vehicle. For example, secondary batteries may be connected to each other in serial or in parallel to form a medium or large size battery pack. Deterioration of a battery pack typically occurs in a process of charging and discharging the secondary batteries, and further occurs in a state in which charging and a discharging of the batteries do not occur, that is, during a battery being stored without use.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In one general aspect, a battery management apparatus includes: a state of charge (SOC) estimator configured to estimate an SOC of a battery; and a storage temperature controller configured to control a storage temperature of the battery based on the SOC of the battery.

The SOC estimator may estimate the SOC of the battery in response to an electric power supply of the battery being discontinued or a critical time passing after the electric power supply of the battery has been discontinued.

The critical time may be 48 hours.

The storage temperature controller may be configured to control the storage temperature of the battery to maintain the storage temperature of the battery below a first target temperature, in response to an SOC value of the battery being equal to or less than a critical SOC value of the battery. The storage temperature controller may be configured to control the storage temperature of the battery to maintain the storage temperature below a second target temperature, in response to the SOC value of the battery exceeding the critical SOC value of the battery.

The critical SOC value may be 50%, the first target temperature may be 25° C., and the second target temperature may be 10° C.

The storage temperature controller may be configured to control the storage temperature of the battery to maintain the storage temperature of the battery below a third target temperature, in response to an SOC value of the battery being in a critical SOC range. The storage temperature controller may be configured to control the storage temperature of the battery to maintain the storage temperature of the battery below a fourth target temperature, in response to the SOC value of the battery exceeding the critical SOC range.

The critical SOC range may be equal to or greater than 30% and equal to or less than 60%, the third target temperature may be 25° C., and the fourth target temperature may be 10° C.

The storage temperature controller may be configured to control the storage temperature of the battery using a cooling system or a heating, ventilation, and air conditioning (HVAC) system.

In another general aspect, a battery management method includes: estimating, using a processor, a state of charge (SOC) of a battery; and controlling, using the processor, a storage temperature of the battery based on the SOC of the battery.

The estimating of the SOC of the battery may include estimating the SOC of the battery in response to an electric power supply of the battery being discontinued or a critical time passing after the electric power supply of the battery has been discontinued.

The critical time may be 48 hours.

The controlling of the storage temperature of the battery may include: controlling the storage temperature of the battery to maintain the storage temperature of the battery below a first target temperature, in response to an SOC value of the battery being equal to or less than a critical SOC value; and controlling the storage temperature of the battery to maintain the storage temperature of the battery below a second target temperature, in response to the SOC value of the battery exceeding the critical SOC value.

The critical SOC value may be 50%, the first target temperature may be 25° C., and the second target temperature may be 10° C.

The controlling of the storage temperature of the battery may include: controlling the storage temperature of the battery to maintain the storage temperature of the battery below a third target temperature, in response to an SOC value of the battery being within a critical SOC range; and controlling the storage temperature of the battery to maintain the storage temperature of the battery below a fourth target temperature, in response to the SOC value of the battery exceeding the critical SOC range.

The critical SOC range may be equal to or greater than 30% and equal to or less than 60%, the third target temperature may be 25° C., and the fourth target temperature may be 10° C.

The controlling of the storage temperature of the battery may include controlling the storage temperature of the battery using a cooling system or an HVAC system.

In another general aspect, a battery management method includes: determining, using a processor, a storage mode of a battery to be a long-term storage mode in which an electric power supply of the battery is discontinued; in response to a state of charge (SOC) value of the battery being greater than a target SOC value during the long-term storage mode, discharging, using the processor, the battery to reduce the SOC value of the battery to the target SOC value; and in response to the SOC value of the battery being less than the target SOC value during the long-term storage mode, charging the battery to increase the SOC value of the battery to the target SOC value.

The method may further include controlling a storage temperature of the battery to maintain the storage temperature of the battery below a first target temperature during the long-term storage mode.

The method may further include: in response to a use time for the battery being set, pre-charging the battery, using the processor, prior to the use time.

Other features and aspects will be apparent from the following detailed description, the drawings, and the claims.

### BRIEF DESCRIPTION OF THE DRAWINGS

FIG. 1 is a block diagram illustrating an embodiment of a battery system.

FIG. 2 is a block diagram illustrating an embodiment of a battery management apparatus.

FIG. 3 is a block diagram illustrating another embodiment of a battery management apparatus.

FIG. 4 is a flow chart illustrating an embodiment of a battery management method.

FIG. 5 is a flow chart illustrating a detailed example of the battery management method of FIG. 4.

FIG. 6 is a flow chart illustrating another detailed example of the battery management method.

FIG. 7 is a flow chart illustrating an embodiment of a battery management method according to a long-term storage mode.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

The terminology used herein is for the purpose of describing particular examples only, and is not to be used to limit the disclosure. As used herein, the terms “a,” “an,” and “the” are intended to include the plural forms as well, unless the context clearly indicates otherwise. As used herein, the terms “include, “comprise,” and “have” specify the presence of stated features, numbers, operations, elements, components, and/or combinations thereof, but do not preclude the presence or addition of one or more other features, numbers, operations, elements, components, and/or combinations thereof.

The features of the examples described herein may be combined in various ways as will be apparent after an understanding of the disclosure of this application. Further, although the examples described herein have a variety of configurations, other configurations are possible as will be apparent after an understanding of the disclosure of this application.

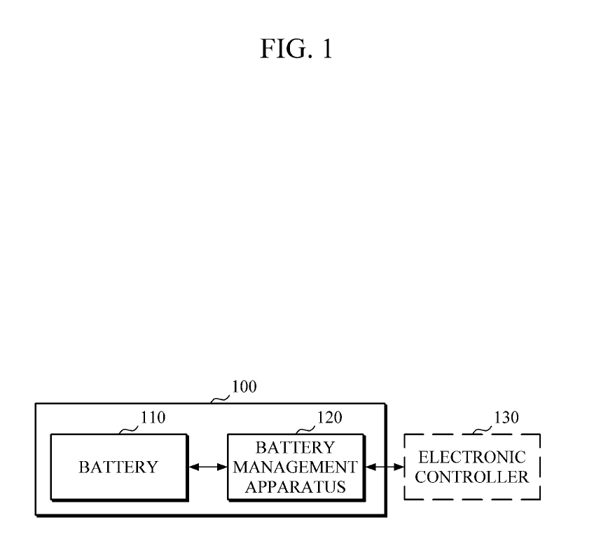

FIG. 1 is a block diagram illustrating one embodiment of a battery system. With reference to FIG. 1, a battery system 100 includes a battery 110 and a battery management apparatus 120.

The battery 110 may supply electric power to an apparatus to which the battery system 100 is mounted or otherwise connected. The battery 110 includes battery modules connected to each other in series and/or in parallel, and each of the battery modules includes battery cells connected to each other in series and/or in parallel. Each battery module or each battery cell may be a secondary battery such as a nickel metal battery or a lithium ion battery. Also, capacities of the battery modules or the battery cells may be the same as each other or different from each other.

The battery management apparatus 120 monitors a state of the battery 110 and manages the battery 100 according to the monitoring result. The battery management apparatus 120 estimates one or both of a state of charge (SOC) and a state of health (SOH) of the battery 110 based on data (for example, a temperature of the battery 110, a voltage and a current of each battery module or each battery cell, and the like) sensed from the battery 110. The SOC represents information regarding a quantity of charge being charged to the battery 110, and the SOH represents information regarding a degree of degradation in a performance of the battery 110 as compared to that of the battery 110 at a time when being manufactured.

According to an embodiment, the battery management apparatus 120 estimates an SOC of the battery 110 through a Coulomb counting, an equivalent circuit modeling technique, an electrochemical modeling technique or a data-based technique. However, the techniques described above are merely examples, and the battery management apparatus 120 may estimate an SOC of the battery 110 through a variety of other techniques.

According to an embodiment, the battery management apparatus 120 estimates an SOH of the battery 110 using an open circuit voltage (OCV) technique which estimates an SOH by measuring an OCV of the battery 110, or an electrochemical impedance spectroscopy (EIS) technique which estimates an SOH by measuring an internal resistance of the battery 110. However, the techniques described above are merely examples, and the battery management apparatus 120 may estimate an SOC of the battery 110 through a variety of other techniques.

The battery management apparatus 120 performs a heat control of the battery 110 or adjusts a voltage or a current of the battery 110 by controlling a cooling system or a heating system so as to maintain an internal temperature or the voltage of the battery 110 within a predetermined, or target, range based on the sensed data.

Also, when an electric power supply of the battery 110 is discontinued, that is, an electric power supply from the battery 110 to an apparatus to which the battery 110 is connected is discontinued, the battery management apparatus 120 controls a storage temperature of the battery 110 based on an SOC of the battery 110. For example, the battery management apparatus 120 controls a cooling system or a heating, ventilation, and air conditioning (HVAC) system to maintain a storage temperature of the battery 110 below a predetermined target temperature according to an SOC of the battery 110.

Also, the battery management apparatus 120 prevents or mitigates an overcharging and an over-discharging of the battery 110 by performing a cell balancing based on the SOC and/or SOH of the battery 110, thereby controlling SOCs between battery modules included in the battery 110 to be equally balanced. Consequently, energy efficiency of the battery 110 may be increased and a lifespan of the battery 110 may be prolonged.

The battery management apparatus 120 provides an electronic controller, or electronic control unit (ECU) 130 with an SOC and an SOH of the battery 110. The battery management apparatus 120 may communicate with the ECU 130 using a controller area network (CAN) communication. However, other communication standards may be used for communication between the battery management apparatus 120 and the ECU 130.

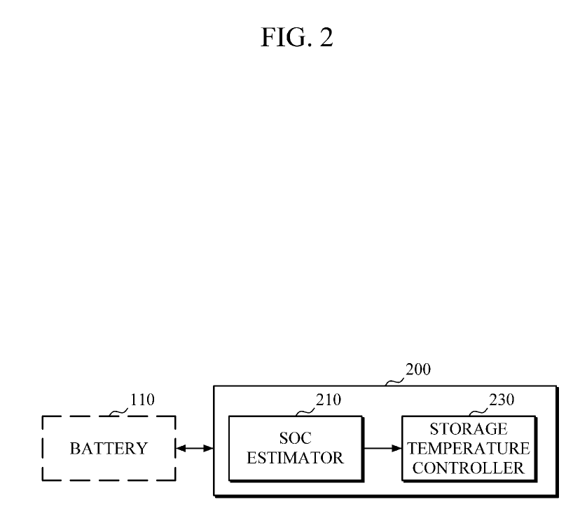

FIG. 2 is a block diagram illustrating a battery management apparatus 200, according to an embodiment. The battery management apparatus 200 may be an embodiment or a component of the battery management apparatus 120 of FIG. 1. Alternatively, the battery management apparatus 200 may be an apparatus separate from the battery management apparatus 120 of FIG. 1.

A battery may be deteriorated by factors including a storage temperature of the battery, a storage time of the battery, and an SOC of the battery at a time when the battery is stored. In particular, a capacity of a battery tends to decrease and a resistance of a battery tends to increase as a storage temperature of the battery is increased, a storage time of the battery is increased, and an SOC of the battery at a time when the battery is stored is increased. Therefore, according to an embodiment, the battery management apparatus 200 improves a performance of a battery by controlling a storage temperature of the battery to minimize a deterioration of the battery.

With reference to FIG. 2, the battery management apparatus 200 includes an SOC estimator 210 and a storage temperature controller 230.

When an electric power supply of the battery 110 is discontinued or a predetermined first critical time passes after the electric power supply of the battery 110 has been discontinued, the SOC estimator 210 estimates an SOC of the battery 110. The discontinuance of the electric power supply of the battery 110 is a discontinuance of an electric power supply from the battery 110 to an apparatus at which the battery 110 is connected. Also, the first critical time may be 48 hours. However, the first critical time is not limited to 48 hours, and may be set according to a performance and purpose of a system in which the battery 110 is implemented.

According to one embodiment, the SOC estimator 210 may estimate an SOC of the battery 110 through a Coulomb counting, an equivalent circuit modeling technique, an electrochemical modeling technique, or a data-based technique. The storage temperature controller 230 controls a storage temperature of the battery 110 based on the estimated SOC of the battery 110.

For example, when an SOC value of the battery 110 is equal to or less than a predetermined critical SOC value, the storage temperature controller 230 controls a storage temperature of the battery 110 to be maintained below a first target temperature. Also, when an SOC value of the battery 110 exceeds the predetermined critical SOC value, the storage temperature controller 230 controls a storage temperature of the battery 110 to be maintained below a second target temperature. The critical SOC value, the first target temperature, and the second target temperature may be experimentally determined by considering an effect that a storage temperature and an SOC at a time when the battery 110 is stored affect a capacity or a resistance characteristic of the battery 110. For example, the critical SOC value may be 50%, the first target temperature may be 25° C., and the second target temperature may be 10° C. However, the critical SOC value, the first target temperature, and the second target temperature are not limited to the aforementioned values, and may be set according to a performance and a purpose of a system in which the battery 110 is implemented.

As another example, when an SOC value of the battery 110 is in a predetermined critical SOC range, the storage temperature controller 230 controls a storage temperature of the battery 110 to be maintained below a third target temperature. Also, when an SOC value of the battery 110 exceeds the predetermined critical SOC range, the storage temperature controller 230 controls a storage temperature of the battery 110 to be maintained below a fourth target temperature. The critical SOC range, the third target temperature, and the fourth target temperature may be experimentally determined by considering an effect that a storage temperature and an SOC at a time when the battery 110 is stored affect a capacity or a resistance characteristic of the battery 110. In an example, the critical SOC range is equal to or greater than 30% and equal to or less than 60%, the third target temperature is 25° C., and the fourth target temperature is 10° C. However, the critical SOC range, the third target temperature, and the fourth target temperature are not limited to the aforementioned values, and may be set according to a performance and a purpose of an apparatus to which the battery 110 is connected.

According to an embodiment, the storage temperature controller 230 controls a storage temperature of the battery 110 using a cooling system or an HVAC system. The storage temperature controller 230 may use external electric power or electric power of the battery 110 to turn on the cooling system or the HVAC system. For example, the cooling system is mounted in an apparatus, such as an electric vehicle or a hybrid vehicle, to which the battery 110 is also mounted, to adjust a temperature of the battery 110. The cooling system may be implemented by a water cooling method using a material in a liquid state, an air cooling method using a material in a gaseous state, and a method in which the water cooling method and the air cooling method are combined with each other. The HVAC system may be an apparatus that is implemented for maintaining comfort in a temperature or humidity inside the apparatus to which a battery is mounted. Also, the external electric power is electric power, other than the power provided by the battery 110, and provided from a device that is external to the battery 110. The external electric power may be a charging electric power provided for charging the battery 110, or electric power provided from a power source which is separately configured for a storage temperature adjustment of the battery 110.

According to an embodiment, the storage temperature controller 230 measures a temperature of the battery 110 and compares the measured battery temperature with a target temperature (the first target temperature, the second target temperature, the third target temperature, or the fourth target temperature), and determines whether or not to turn on the cooling system or the HVAC system based on the comparison result. For example, when a temperature of the battery 110 is higher than a target temperature, the storage temperature controller 230 turns on the cooling system or the HVAC system to lower the temperature of the battery 110. Thus, when the temperature of the battery 110 is equal to or less than the target temperature, the storage temperature controller 230 turns off the cooling system or the HVAC system. When the temperature of the battery 110 is again higher than the target temperature after the cooling system or the HVAC system has been turned off, the storage temperature controller 230 turns on the cooling system or the HVAC system again to lower the temperature of the battery 110.

In order to control a storage temperature of the battery 110, the storage temperature controller 230 measures a temperature of the battery 110. For example, a temperature of the battery 110 is estimated based on a temperature of cooling water flowing around the battery 110, or is sensed using a temperature sensor installed at the battery 110. However, a temperature of the battery 110 may be measured through a variety of methods other than the aforementioned methods.

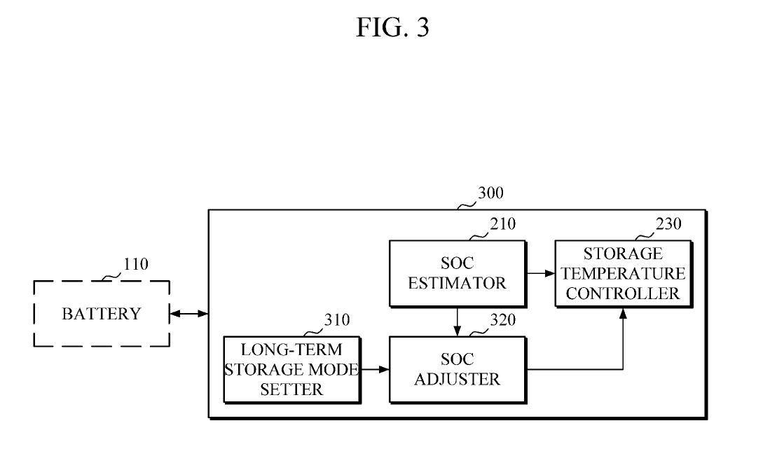

FIG. 3 is a block diagram illustrating a battery management apparatus 300, according to another embodiment. The battery management apparatus 300 may be an embodiment of the battery management apparatus 120 of FIG. 1, or a component of the battery management apparatus 120. Alternatively, the battery management apparatus 300 may be an apparatus that is separate from the battery management apparatus 120 of FIG. 1.

With reference to FIG. 3, the battery management apparatus 300 further includes a long-term storage mode setter 310 and an SOC adjuster 320 as compared with the battery management apparatus 200 of FIG. 2. The long-term storage mode setting unit 310 sets a battery storage mode to a long-term storage mode. The battery management apparatus 300 supports the long-term storage mode as a battery storage mode. The long-term storage mode is a mode for storing the battery 110 for a relatively long time in a state in which electric power of the battery 110 is discontinued.

According to an embodiment, the long-term storage mode setter 310 sets a battery storage mode to a long-term storage mode according to an input of a user or an electric power discontinuance period of the battery 110. For example, when an input indicating a long-term storage of the battery 110 is made by a user, or an electric power discontinuance period of the battery 110 passes a second predetermined critical unused period, the long-term storage mode setting unit 310 sets the battery storage mode to a long-term storage mode. The second critical unused period may be two weeks. However, the second critical unused period is not limited to two weeks, and may be set according to a performance and a purpose of a system in which the battery 110 is implemented.

The SOC adjustment unit 320 adjusts an SOC of the battery 110 to a predetermined, or target, SOC value when the battery storage mode is a long-term storage mode. The predetermined SOC value may be experimentally determined by considering an effect that a storage temperature, an SOC at a time when a battery is stored, and a storage term affect a capacity of a battery or a resistance characteristic of a battery. In an example, the predetermined SOC value is 50. However, the predetermined SOC value may be a different value, and may be set according to a capacity or a purpose of a system in which the battery 110 is provided.

For example, in a long-term storage mode, in response to the SOC value of the battery 110 being greater than a predetermined, or target, SOC value, the SOC adjuster 320 discharges the battery 110 to bring the SOC value of the battery 110 down to the predetermined value. Otherwise, in response to the SOC value of the battery 110 being less than the predetermined SOC value, the SOC adjuster 320 charges the battery 110 to bring the SOC value of the battery 110 up to the predetermined SOC value.

Additionally, when a battery storage mode is a long-term storage mode, the storage temperature controller 230 controls a storage temperature of the battery 110 to maintain the storage temperature of the battery 110 below a fifth target temperature. The fifth target temperature may be experimentally determined by considering an effect that a storage temperature, an SOC at a time when a battery is stored, and a storage term affect a capacity of a battery or a resistance characteristic of a battery. In an example, a fifth target temperature is 25° C. However, the fifth target temperature is not limited to 25° C., and may be set according to a performance and a purpose of a system in which the battery 110 is implemented.

Additionally, in the long-term storage mode, when a user sets a use time of the battery 110, the SOC adjuster 320 starts charging the battery 110 before a predetermined time in advance of the use time of the battery 110, which is set by the user, to enable the battery 110 to be used at the use time set by the user.

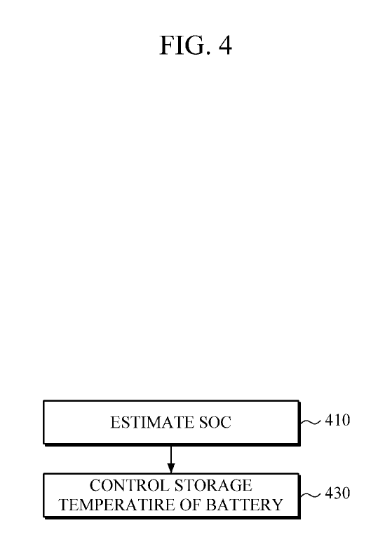

FIG. 4 is a flow chart illustrating an embodiment of a battery management method. With reference to FIGS. 2 and 4, when an electric power supply of a battery is discontinued or a predetermined first critical time passes after the electric power supply of the battery to an apparatus connected to the battery has been discontinued, the battery management apparatus 200 estimates an SOC of the battery in operation 410. The first critical period may be 48 hours. However, the first critical period may be a different period of time, and may be set according to a performance and a purpose of a system in which the battery is implemented.

For example, the battery management apparatus 200 estimates an SOC of the battery through a Coulomb counting, an equivalent circuit modeling technique, an electrochemical modeling technique, or a data-based technique. The battery management apparatus 200 controls a storage temperature of the battery based on the estimated SOC of the battery in operation 430.

For example, when an SOC value of a battery is equal to or less than a predetermined critical SOC value, the battery management apparatus 200 controls a storage temperature of the battery to be maintained below a first target temperature. Also, when the SOC value of the battery exceeds the predetermined critical SOC value, the battery management apparatus 200 controls the storage temperature of the battery to be maintained below a second target temperature. The critical SOC value, the first target temperature, and the second target temperature may be experimentally determined by considering an effect that a storage temperature and an SOC at a time when a battery is stored affect a capacity of a battery or a resistance characteristic of the battery. In an example, the critical SOC value is 50%, the first target temperature is 25° C., and the second target temperature is 10° C. However, the first target temperature, and the second target temperature are not limited to the example values provided, and may be set according to a performance and a purpose of a system in which the battery is implemented.

As another example, when an SOC value of a battery is within a predetermined critical SOC range, the battery management apparatus 200 controls a storage temperature of the battery to be maintained below a third target temperature. Also, when the SOC value of the battery exceeds the predetermined critical SOC range, the battery management apparatus 200 controls the storage temperature of the battery to be maintained below a fourth target temperature. The critical SOC range, the third target temperature, and the fourth target temperature may be experimentally determined by considering an effect that a storage temperature and an SOC at a time when a battery is stored affect a capacity of a battery or a resistance characteristic of the battery. In an example, the critical SOC range is equal to or greater than 30% and equal to or less than 60%, the third target temperature is 25° C., and the fourth target temperature is 10° C. However, the critical SOC range, the third target temperature, and the fourth target temperature are not limited to the example values provided, and may be set according to a performance and a purpose of an apparatus connected to the battery.

According to an embodiment, the battery management apparatus 200 controls a temperature of a battery using a cooling system or an HVAC system. The battery management apparatus 200 may use external electric power or electric power being stored in a battery to turn on the cooling system or the HVAC system.

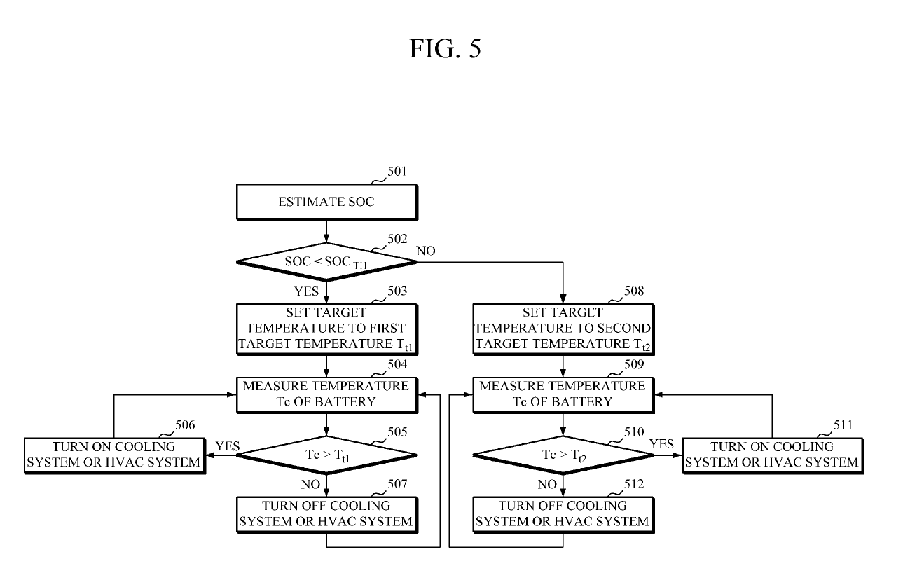

FIG. 5 is a detailed flow chart illustrating a detailed example the battery management method of FIG. 4. With reference to FIGS. 2 and 5, when an electric power supply of a battery is discontinued or a predetermined firs critical time passes after the electric power supply of the battery has been discontinued, the battery management apparatus 200 estimates an SOC of the battery in operation 501.

The battery management apparatus 200 compares the estimated SOC value with a predetermined threshold SOC value SOC_{TH} in operation 502, and, if the estimated SOC value is equal to or less than the predetermined threshold SOC value SOC_{TH}, sets a target temperature to a first target temperature Tₜ₁ in operation 503. The threshold SOC value SOC_{TH} may be 50%, and the first target temperature Tₜ₁ may be 25° C.

The battery management apparatus 200 measures a temperature T_{c} of the battery in operation 504, and compares the measured temperature T_{c} of the battery with the first target temperature Tₜ₁ in operation 505.

In response to the temperature T_{c} of the battery being greater than the first target temperature Tₜ₁, the battery management apparatus 200 turns on the cooling system or the HVAC system in operation 506 to lower the temperature T_{c} of the battery. Otherwise, in response to the temperature T_{c} of the battery being equal to or less than the first target temperature Tₜ₁, the battery management apparatus 200 turns off the cooling system or the HVAC system in operation 507.

Thereafter, the battery management apparatus 200 may repeatedly perform operations 504 to 507 to maintain the temperature of the battery below the first target temperature Tₜ₁.

When the estimated SOC value exceeds the predetermined threshold SOC value SOC_{TH} as a result of comparing of the estimated SOC value with the predetermined threshold SOC value SOC_{TH} (operation 502), the battery management apparatus 200 sets the target temperature to a second target temperature Tₜ₂ in operation 508. The second target temperature Tₜ₂ may be 10° C.

The battery management apparatus 200 measures the temperature T_{c} of the battery in operation 509, and compares the temperature T_{c} of the battery with the second target temperature Tₜ₂ in operation 510.

In response to the temperature T_{c} of the battery being higher than the second target temperature Tₜ₂, the battery management apparatus 200 turns on the cooling system or the HVAC system in operation 511 to lower the temperature of the battery. Otherwise, in response to the temperature T_{c} of the battery being equal to or lower than the second target temperature Tₜ₂, the battery management apparatus 200 turns off the cooling system or the HVAC system in Operation 512.

Thereafter, the battery management apparatus 200 may repeatedly perform operations 509 to 512 to maintain the temperature of the battery below the second target temperature Tₜ₂.

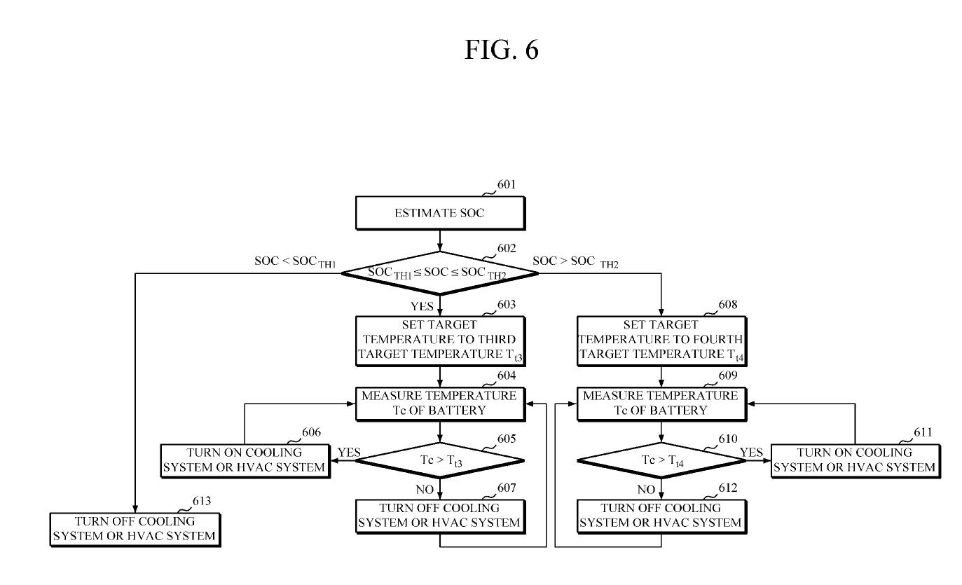

FIG. 6 is a detailed flow chart illustrating another detailed example of the battery management method of FIG. 4. With reference to FIGS. 2 and 6, when an electric power supply of the battery is discontinued or a predetermined first critical time passes after the electric power supply of the battery has been discontinued, the battery management apparatus 200 estimates an SOC of the battery in operation 601.

The battery management apparatus 200 compares the estimated SOC value with a predetermined threshold SOC range (equal to or greater than an SOC_{TH1} and equal to or less than an SOC_{TH2}) in operation 602, and, if the estimated SOC value is within the predetermined threshold SOC range (equal to or greater than the SOC_{TH1} and equal to or less than the SOC_{TH2}), sets a target temperature to a third target temperature Tₜ₃ in operation 603. The SOC_{TH1} may be 30%, the SOC_{TH2} may be 60%, and the third target temperature Tₜ₃ may be 25° C.

The battery management apparatus 200 measures a temperature T_{c} of the battery in operation 604, and compares the temperature T_{c} of the battery with the third target temperature Tₜ₃ in operation 605.

When the temperature T_{c} of the battery is higher than third target temperature Tₜ₃, the battery management apparatus 200 turns on the cooling system or the HVAC system in operation 606 to lower the temperature of the battery. Otherwise, when the temperature T_{c} of the battery is equal to or lower than the third target temperature Tₜ₃, the battery management apparatus 200 turns off the cooling system or the HVAC system in operation 607.

Thereafter, the battery management apparatus 200 may repeatedly perform operations 604 to 607 to maintain the temperature of the battery below the third target temperature Tₜ₃.

Also, when the estimated SOC value exceeds the predetermined threshold SOC range (equal to or greater than an SOC_{TH1} and equal to or less than an SOC_{TH2}) as the result of comparing the estimated SOC value with the predetermined threshold SOC range (that is, the estimated SOC value exceeds SOC_{TH2} in operation 602), the battery management apparatus 200 sets the target temperature to a fourth temperature Tₜ₄ in operation 608. The fourth temperature Tₜ₄ may be 10° C.

The battery management apparatus 200 measures the temperature T_{c} of the battery in operation 609, and compares the temperature T_{c} of the battery with the fourth temperature Tₜ₄ in operation 610.

In response to the temperature T_{c} of the battery being higher than the fourth temperature Tₜ₄, the battery management apparatus 200 turns on the cooling system or the HVAC system in operation 611 to lower the temperature of the battery. Otherwise, in response to the temperature T_{c} of the battery being equal to or lower than the fourth temperature Tₜ₄, the battery management apparatus turns off the cooling system or the HVAC system in operation 612.

Thereafter, the battery management apparatus 200 may repeatedly perform operations 609 to 612 to maintain the temperature of the battery below the fourth temperature Tₜ₄.

When the estimated SOC value is less than the predetermined threshold SOC range (equal to or greater than the SOC_{TH1} and equal to or less than the SOC_{TH2}) as the result of comparing the estimated SOC value with the predetermined threshold SOC range in operation 602 (that is, the estimated SOC value is less than the SOC_{TH1}), the battery management apparatus 200 turns off the cooling system or the HVAC system to prevent an unnecessary electric power consumption.

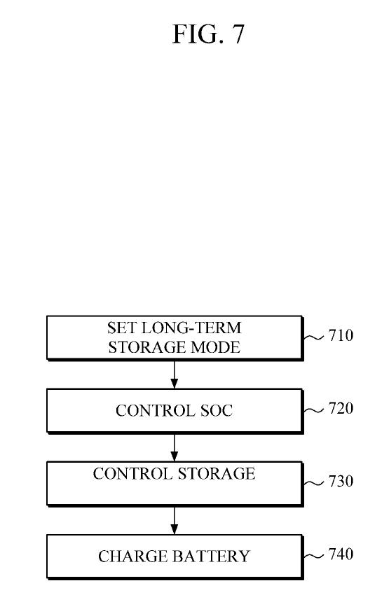

FIG. 7 is a flow chart illustrating an embodiment of a battery management method according to a long-term storage mode. With reference to FIGS. 3 and 7, the battery management apparatus 300 sets a battery storage mode to a long-term storage mode in operation 710. The long-term storage mode is a mode of storing a battery for a relatively long time under a state of discontinuing an electric power supply of the battery.

For example, the battery management apparatus 300 sets a battery storage mode to a long-term storage mode according to an input of a user or an electric power supply discontinuance time of the battery. For instance, when a user input for a long-term storage of a battery is made or an electric power supply discontinuance time of the battery passes a predetermined second critical time, the battery management apparatus 300 sets the battery storage mode to the long-term storage mode. The second critical time may be two weeks, but may be another period of time, and may be set according to a performance or a purpose of a system in which the battery is implemented.

When the battery storage mode is the long-term storage mode, the battery management apparatus 300 adjusts an SOC value of the battery to a predetermined, or target, SOC value in operation 720. The predetermined SOC value may be experimentally determined by considering an effect that a storage temperature, an SOC at a time when a battery is stored, and a storage time affect a capacity of the battery or a resistance characteristic of a battery. In an example, the predetermined SOC value is 50%, but may be a different value, and may be set according to a performance or a purpose of a system in which the battery is implemented.

For instance, in the long-term storage mode, in response to the SOC value of the battery being greater than the predetermined SOC value, the battery management apparatus 300 discharges the battery to bring the SOC value of the battery down to the predetermined SOC value. Otherwise, in response to the SOC value of the battery being less than the predetermined SOC value, the battery management apparatus 300 charges the battery to bring the SOC value of the battery up to the predetermined SOC value.

When the battery storage mode is the long-term storage mode, the battery management apparatus 300 controls a storage temperature of the battery in operation 730 to maintain a temperature of the battery below a fifth target temperature. The fifth target temperature may be experimentally determined by considering an effect that a storage temperature, an SOC at a time when a battery is stored, and a storage time affect a capacity of the battery or a resistance characteristic of the battery. In an example, the fifth target temperature is 25° C. However, the fifth target temperature may have a different value, and may be set according to a performance or a purpose of a system in which the battery is implemented.

When a user sets a use time of the battery, the battery management apparatus 300 starts to charge the battery, in operation 740, before a predetermined time in advance of the use time set by the user to enable the battery 100 to be used at the use time set by the user.

The electronic controller 130, the SOC estimator 210, the storage temperature controller 230, the long-term storage mode setter 310 and the SOC adjuster 320 in FIGS. 1-3 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 4-7 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A battery management apparatus, comprising:
a state of charge (SOC) estimator configured to estimate an SOC of a battery; and
a storage temperature controller configured to control a storage temperature of the battery based on the SOC of the battery.

2. The battery management apparatus of claim 1, wherein the SOC estimator estimates the SOC of the battery in response to an electric power supply of the battery being discontinued or a critical time passing after the electric power supply of the battery has been discontinued.

3. The battery management apparatus of claim 2, wherein the critical time is 48 hours.

4. The battery management apparatus of claim 1, wherein:
the storage temperature controller is configured to control the storage temperature of the battery to maintain the storage temperature of the battery below a first target temperature, in response to an SOC value of the battery being equal to or less than a critical SOC value of the battery; and
the storage temperature controller is configured to control the storage temperature of the battery to maintain the storage temperature below a second target temperature, in response to the SOC value of the battery exceeding the critical SOC value of the battery.

5. The battery management apparatus of claim 4, wherein the critical SOC value is 50%, the first target temperature is 25° C., and the second target temperature is 10° C.

6. The battery management apparatus of claim 1, wherein:
the storage temperature controller is configured to control the storage temperature of the battery to maintain the storage temperature of the battery below a third target temperature, in response to an SOC value of the battery being in a critical SOC range; and
the storage temperature controller is configured to control the storage temperature of the battery to maintain the storage temperature of the battery below a fourth target temperature, in response to the SOC value of the battery exceeding the critical SOC range.

7. The battery management apparatus of claim 6, wherein the critical SOC range is equal to or greater than 30% and equal to or less than 60%, the third target temperature is 25° C., and the fourth target temperature is 10° C.

8. The battery management apparatus of claim 1, wherein the storage temperature controller is configured to control the storage temperature of the battery using a cooling system or a heating, ventilation, and air conditioning (HVAC) system.

9. A battery management method, comprising:
estimating, using a processor, a state of charge (SOC) of a battery; and
controlling, using the processor, a storage temperature of the battery based on the SOC of the battery.

10. The battery management method of claim 9, wherein the estimating of the SOC of the battery comprises estimating the SOC of the battery in response to an electric power supply of the battery being discontinued or a critical time passing after the electric power supply of the battery has been discontinued.

11. The battery management method of claim 10, wherein the critical time is 48 hours.

12. The battery management method of claim 9, wherein the controlling of the storage temperature of the battery comprises:
controlling the storage temperature of the battery to maintain the storage temperature of the battery below a first target temperature, in response to an SOC value of the battery being equal to or less than a critical SOC value; and
controlling the storage temperature of the battery to maintain the storage temperature of the battery below a second target temperature, in response to the SOC value of the battery exceeding the critical SOC value.

13. The battery management method of claim 12, wherein the critical SOC value is 50%, the first target temperature is 25° C., and the second target temperature is 10° C.

14. The battery management method of claim 9, wherein the controlling of the storage temperature of the battery comprises:
controlling the storage temperature of the battery to maintain the storage temperature of the battery below a third target temperature, in response to an SOC value of the battery being within a critical SOC range; and
controlling the storage temperature of the battery to maintain the storage temperature of the battery below a fourth target temperature, in response to the SOC value of the battery exceeding the critical SOC range.

15. The battery management method of claim 14, wherein the critical SOC range is equal to or greater than 30% and equal to or less than 60%, the third target temperature is 25° C., and the fourth target temperature is 10° C.

16. The battery management method of claim 11, wherein the controlling of the storage temperature of the battery comprises controlling the storage temperature of the battery using a cooling system or an HVAC system.

17. A battery management method comprising:
determining, using a processor, a storage mode of a battery to be a long-term storage mode in which an electric power supply of the battery is discontinued;
in response to a state of charge (SOC) value of the battery being greater than a target SOC value during the long-term storage mode, discharging, using the processor, the battery to reduce the SOC value of the battery to the target SOC value; and
in response to the SOC value of the battery being less than the target SOC value during the long-term storage mode, charging the battery to increase the SOC value of the battery to the target SOC value.

18. The method of claim 17, further comprising:
controlling a storage temperature of the battery to maintain the storage temperature of the battery below a first target temperature during the long-term storage mode.

19. The method of claim 17, further comprising:
in response to a use time for the battery being set, pre-charging the battery, using the processor, prior to the use time.
